(19) United States
(12) Patent Application Publication
(10) Pub. No.: US 2014/0251004 A1
(43) Pub. Date: Sep. 11, 2014

(54) METHOD AND SYSTEM FOR FLOW MEASUREMENT

(71) Applicant: WEATHERFORD CANADA PARTNERSHIP, Calgary (CA)

(72) Inventors: Kirk H. Bevan, Glencoe (CA); Stuart Bevan, Glencoe (CA); Srinivasa R. Sampath, Glencoe (CA)

(73) Assignee: WEATHERFORD CANADA PARTNERSHIP, Calgary, AB (CA)

(21) Appl. No.: 14/353,174

(22) PCT Filed: Oct. 26, 2012
(86) PCT No.: PCT/CA2012/000995

§ 371 Date: Apr. 21, 2014

Related U.S. Application Data
(60) Provisional application No. 61/551,540, filed on Oct. 26, 2011.
(60) Provisional application No. 61/551,542, filed on Oct. 26, 2011.

(51) Int. Cl. G01F 1/688; G01F 1/69

(52) U.S. Cl. CPC G01F 1/688; G01F 1/69
USPC 73/204.25; 73/204.23

(57) ABSTRACT

A method for determining flow in a medium, comprising applying thermal energy to at least one probe of a pair of probes, the probes configured for placement in the medium and varying the applied thermal energy of the at least one probe to maintain a constant temperature differential between the pair of probes and determining a flow from the applied thermal energy while maintaining the constant temperature differential.

### FIELD OF THE DISCLOSURE

The present disclosure relates to flow sensing devices and methods and more particularly to flow sensors employed in pump control systems for non-homogenous or multiphase media.

### BACKGROUND

A generalized pump control system 100 for a fluid type medium is shown in FIG. 1. A pump 102 generates a flow 104 of the medium, which is sensed by a thermal dispersion based sensor 106 having probes 108 inserted in the flow 104. A sensor controller 110 (generally integrated with the sensor) controls the sensor probes and provides signals (indicative of flow) to a pump controller 112 which uses the flow signals to control the speed of the pump 102.

The known thermal dispersion flow sensor 106 is illustrated in FIG. 2. The thermal dispersion sensor has a pair of probes 202, 204 that are spaced apart in the flow of the medium (medium as used herein includes homogenous, non-homogenous or multiphase fluids and gasses). One of the probes is heated by a constant power source (not shown) and the other probe rests at ambient temperature. A flow past the probes introduces a temperature differential ΔT=T_{H}−T_{A} between the probes as heat is drawn away from one or both probes. As flow increase or decreases this temperature differential changes over time which then provides an indication of flow. The sensor controller 110 functions to maintain the power source constant and to measure the changing temperature differential. In some cases the power source may be switched between the probes so that the heated and ambient probe assignment is alternated to avoid particulate build up on the probes. This is particularly useful if used to measure flow in a fluid having high wax content, typically found in non-homogenous oil extraction systems.

In the known thermal dispersion flow sensor 106 each probe of has a heater resistor R_{H} and platinum resistance temperature device (R_{RTD}). The two probes are identical; however only one is heated at any given time to provide the temperature differential (ΔT) for sensing flow. The platinum resistance temperature devices (RTDs) in the ambient probe and heated probe measure the respective probe temperatures. In this conventional approach, a constant current (I_{H}) is passed through the heater resistor R_{H} to supply a constant power I_{H}²R_{H}, typically 8 W. Since the energy supplied to the heated probe is constant, flow past the sensor decreases its temperature. Thus any increase in flow will be measurable (via the platinum RTDs) as a decrease in the temperature differential between the heated and ambient probe. Increasing flow velocity results in more rapid diffusion of the I_{H}²R_{H} power supplied to the heated probe. With steadily increasing flow velocity, the heated probe temperature asymptotically approaches the ambient probe temperature.

While the thermal dispersion probe described above may be employed in many fluid types, there are situations where because of the properties of the fluid that this type of sensor can be impractical or ineffective. For example in high and low temperature fluids, as well as high and low flow situations the constant power output of the heater may not provide a sufficient temperature differential (ΔT). Furthermore in some situations the additional heating is an explosive hazard.

### SUMMARY

The present disclosure provides a method for determining flow in a medium, comprising: applying thermal energy to at least one probe of a pair of probes, the probes configured for placement in the medium; and varying the applied thermal energy of the at least one probe to maintain a constant temperature differential between the pair of probes; and determining a flow from the applied thermal energy while maintaining the constant temperature differential.

In one embodiment the thermal energy is supplied by an electrical heating element and the flow is determined from a power supplied to the electrical element.

In one embodiment the heating element is a resistor.

In one embodiment the heating element is a thermoelectric module.

In one embodiment the thermal energy is supplied by a thermoelectric element to cool the at least one probe and the flow is determined from a power supplied to the thermoelectric element.

The present disclosure further provides a system for determining flow in fluid comprising: pair of probes; a heat source or heat sink connectable to at least one of said probes, the heat source for heating or heat sink for cooling at least one probe to maintain a constant temperature differential across the pair of probes; and means for determining a flow from a power provided by said heat source or heat sink to maintain said constant temperature differential.

The present disclosure further provides a thermal dispersion sensor comprising: pair of probes; a thermal energy element connectable to at least one of the probes, the thermal energy element for heating or cooling at least one probe ( ); a variable power source connectable to said thermal energy element) and controllable to vary power provided to the thermal energy element; temperature sensing elements for sensing a temperature of the probes; and a microcontroller for receiving temperature information from the temperature sensing elements and for controlling the variable power source to maintain a constant temperature differential across the probes

In one embodiment the thermal energy element is a resistor.

In one embodiment the thermal energy element is a thermoelectric module.

A system for determining flow in fluid comprising at least a pair of probes; a thermal energy element connectable to at least one of said probes, the thermal energy element for heating or cooling at least one probe to maintain a constant temperature differential across the pair of probes; and a controller for determining a flow from a power provided to said thermal energy element to maintain said constant temperature differential.

A thermal dispersion sensor comprising: a pair of probes; a thermal energy element connectable to at least one of the probes, the thermal energy element for heating or cooling at least one probe ( ); a variable power source connectable to the thermal energy element) and controllable to vary power provided to the thermal energy element; temperature sensing elements for sensing a temperature of the probes; and a microcontroller for receiving temperature information from the temperature sensing elements and for controlling said variable power source to maintain a constant temperature differential across said probes.

The present disclosure still further provides a microcontroller for a thermal dispersion sensor, the microcontroller comprising a processor configured to control heating or cooling to at least one probe of a pair of probes, the probes configured for placement in the medium; varying the heating or cooling of at least one probe to maintain a constant temperature differential between the pair of probes; and determining a flow while maintaining the constant temperature differential.

The present disclosure still further provides a pump control system comprising a pump for generating a flow in a fluid; a pump controller for receiving flow signals from a sensor controller, the sensor comprising: a pair of probes for insertion in said flow; a heat source or heat sink connectable to at least one of said probes, the heat source for heating or heat sink for cooling at least one probe; a variable power source connectable to said heat source or heat sink and controllable to vary power provided to said heat source or heat sink; temperature sensing elements for sensing a temperature of said probes; and a microcontroller for receiving temperature information from said temperature sensing elements and for controlling said variable power source to maintain a constant temperature across said probes; and means for determining the flow from a power provided by said variable power source to maintain said constant temperature differential; and the pump controller using the received flow to control the pump.

### BRIEF DESCRIPTION OF THE DRAWINGS

The present disclosure will be better understood with reference to the drawings in which:

FIG. 1 shows a schematic diagram of a pump control system;

FIG. 2 shows a schematic diagram of a thermal dispersion sensor;

FIG. 3 shows a schematic diagram of a sensor according to one embodiment of the present matter;

FIG. 4 shows a graph of flow velocity and heater current for a sensor according to one embodiment of the present matter;

FIG. 5 shows a schematic diagram of a sensor controller according to one embodiment of the present matter;

FIG. 6 shows a flow chart of the sensor controller algorithm implemented with a digital signal processor according to one embodiment of the present matter;

FIG. 7 shows a graph of flow and heater current for a sensor according to one embodiment of the present matter;

FIG. 8 shows a flow chart for a pump controller according to an embodiment of the present matter; and

FIG. 9 shows a cross sectional view of a thermoelectric sensor according to one embodiment of the present matter.

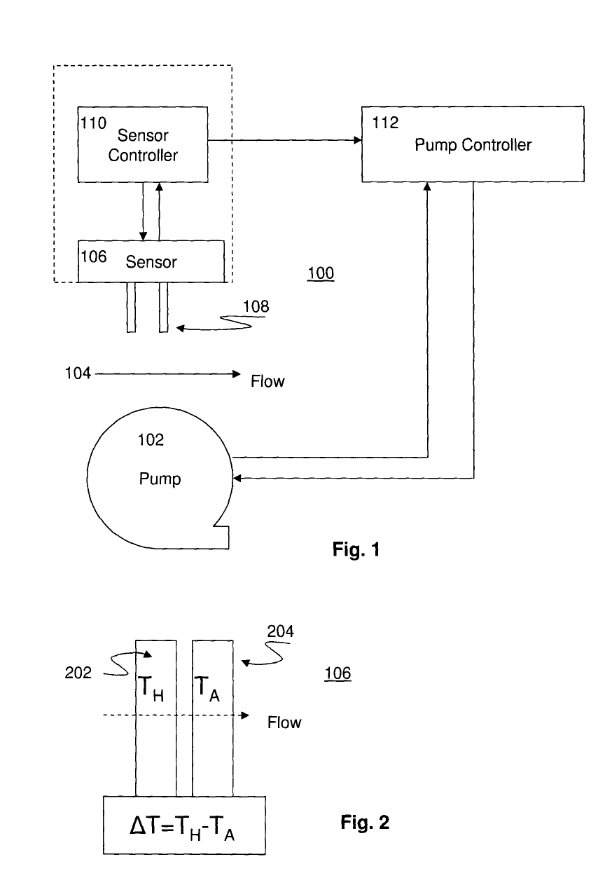

### DETAILED DESCRIPTION

As indicated earlier a conventional approach is to measure a changing temperature differential over time between a pair of probes while maintaining a constant heating power. However in high and low temperature fluids, as well as high and low flow situations, the constant power output of the heater in this conventional approach may not provide a sufficient temperature differential (ΔT). Also in some situations supplying heat to the medium may result in a hazardous situation.

The present disclosure describes an approach where a constant temperature differential ΔT is maintained between a pair of probes placed in a flow of a medium, applying thermal energy to at least one probe and varying the applied thermal energy of the at least one probe to maintain a constant temperature differential between the pair of probes; and determining a flow from the applied thermal energy while maintaining the constant temperature differential.

If a heat source approach is implemented then the flow is determined by varying the heat provided by a heat source to maintain the constant temperature differential between the heated and ambient probes; and determining at the constant temperature differential a power provided by the heat source to the heater to maintain the constant temperature differential. The power determined is then used to calculate the flow or used in the control of a pump etc. as described later. Similarly a heat pump may be used, in effect cooling one of the probes relative to the other. Power to the heat pump may be controlled to maintain a constant temperature differential and this power may be used to determine the flow. These approaches are described in detail below.

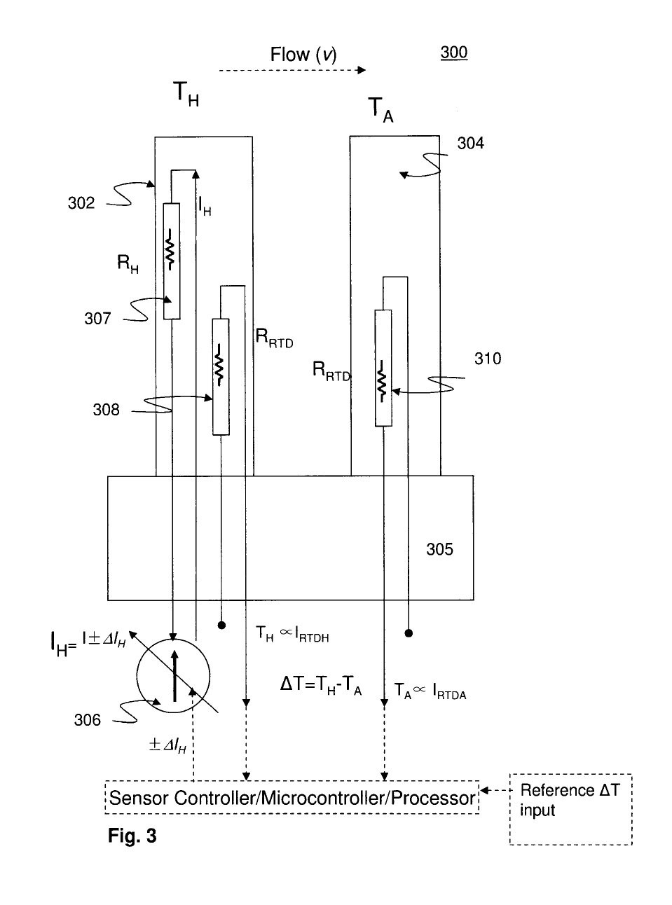

Referring now to FIG. 3, there is shown schematically a sensor 300 according to one embodiment of the present matter. The sensor 300 is a passive device in that it must be powered from a controller (discussed later). The sensor 300 comprises a pair of spaced probes 302, 304 projecting from a probe body 305 which may be threaded for installing in a bore of a T-pipe section or the like for insertion into the flow as is known in the art. The actual orientation of the probes within the flow is not critical; however, the probes should project generally perpendicularly to the direction of flow. The probes may each be comprised of a hollow polished stainless steel tube. Although other materials and geometries will be apparent to those in the art.

For ease of description the probes are designated a heated probe (H) and an ambient probe (A). The heated probe 302 includes a heating element which in one embodiment is comprised of heater resistor R_{H} 307 which is heated by a current I_{H} provided by variable current source 306 (the variable current source or variable power source may be integrated with the sensor body or provided separately with the controller described later) and a temperature sensing element separated from the heating element 307, the sensing element in one embodiment is comprised of a platinum resistance temperature device R_{RTD} 308. The temperature sensing element 308 produces a signal indicative of the temperature of the probe in this case the RTD carries a current I_{RTDH}. The ambient probe 304 also includes a temperature sensing element comprised of platinum resistance temperature device R_{RTD} 310 for generating a current I_{RTDA} indicative of the temperature of the ambient probe. Heating current derived from the variable current source 306 is provided to the heating element 307 via a suitable electrical conductor (not shown) and temperature measurement signals are returned from the temperature sensing elements to the controller via a pair of conductors (not shown) or other suitable means. The variable current/power source is controlled by the sensor controller as described later.

Operation of the sensor 300 is first described. As mentioned previously, the sensor 300 operates on the principle of maintaining a constant temperature difference between the heated probe 302 and the ambient probe 304, the heated probe is supplied with energy which radiates out as heat into the medium. The energy supplied to the heated probe must be varied to maintain the constant temperature differential. The amount of energy supplied to maintain this temperature differential may be determined and used as an indicator of flow. Referring back to FIG. 3, the current I_{H} that is provided to the heater element (heater resistor R_{H},) must be varied continuously to the probe so that the electrical power input to the heater resistor matches the heat/energy diffusion rate from the probe into the medium. Thus as the flow velocity of the medium increases, I_{H} will also increase so as to compensate for the temperature drop of the heated probe due to the medium (the other probe will generally be at the ambient temperature of the medium) and maintain a constant temperature differential between the heated and ambient probe. The temperature of the ambient probe is also determined by its own RTD as in the heated probe. In this constant temperature differential approach, heater current is indicative of flow. In other words, the heater current can first be correlated to velocity (see discussion below) which in turn can be correlated to actual flow by considering a cross-section of the flow medium (typically a conduit). The control method can be used to measure flow.

The principle of operation may be better understood by considering a simplified mathematical description. The relationship between the power provided to the heated probe and the heat energy diffusion rate to the medium, taking into account conduction, convection and radiation modes of heat transfer, including the orientation of the probes in the medium, can be expressed as,

I_{H}²R_{H}=K_{C}hA(T_{H}−T_{A}) (1)

Where K_{C} is a correction factor for all modes of heat transfer and probe orientation, h is the convective heat transfer coefficient, A is the probe heat transfer area, T_{H} is the heated probe temperature, and T_{A} is the ambient temperature of the medium (or temperature of the ambient probe).

The convective heat coefficient h can be expanded as a function of fluid velocity v, such that

h=a+b\sqrt{v} (2)

where the variables a and b are empirical parameters which depend on the medium (e.g. oil versus water). Finally, the energy output of the heated probe (I_{H}²R_{H}) can be related directly to the temperature differential ΔT=(T_{H}−T_{A}) between the probes,

I_{H}²R_{H}=(c₁+c₂\sqrt{v})DT. (3)

In Eq. 3 several constants are wrapped together such that c₁=K_{C}Aa and c₂=K_{C}Ab. The temperatures T_{H} and T_{A} are measured by the temperature sensing elements—the platinum RTDs in each probe. Therefore, to maintain a constant temperature differential ΔT the heated probe energy output must be raised as the fluid velocity increases (and vice versa). This is accomplished by raising and lowering I_{H}. With I_{H} now taken as the new measure of flow velocity, since ΔT is constant, a separate control algorithm is employed to constantly vary the heater current and match the left hand and right hand sides of Eq. 3 at all times.

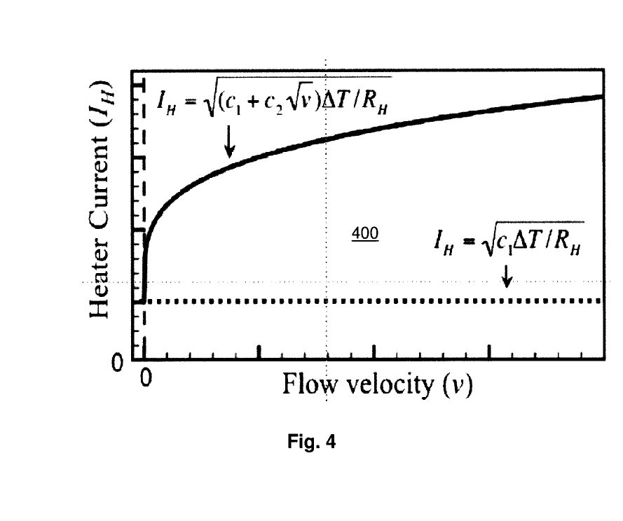

Referring now to FIG. 4 there is shown a graph of the relationship between the heater current and the flow velocity. This relationship may be expressed by the function below where ΔT and R_{H} are parameters of the sensor as described previously:

I_{H}=\sqrt{(c₁+c₂\sqrt{v})ΔT/R_{H}} (4)

The function is illustrated in the graph 300 of FIG. 4, specifically the graph 300 shows flow velocity v on an x-axis and heater current I_{H} on a Y-axis with the graph of current versus flow velocity determined by Eq. 4 (plotted as a solid line) and the zero flow heat constant temperature difference relation (marked with a dotted line). From the graph it may be seen that that the first heat transfer coefficient c₁ dominates at low flow velocities and the second heat transfer coefficient c₂ appears at high velocities. This deserves careful attention in variable and multiphasic fluids (where the heat transfer coefficients c₁ and c₂ vary) in order to avoid or reduce false positives. That is, falsely detecting flow changes when no such change has occurred—in other words while the I_{H} value required to maintain a constant ΔT may have varied, this may be merely because the fluid heat conduction coefficients have changed and not because the flow has changed. This multiphasic flow control can be addressed with a flow control algorithm as will be described below.

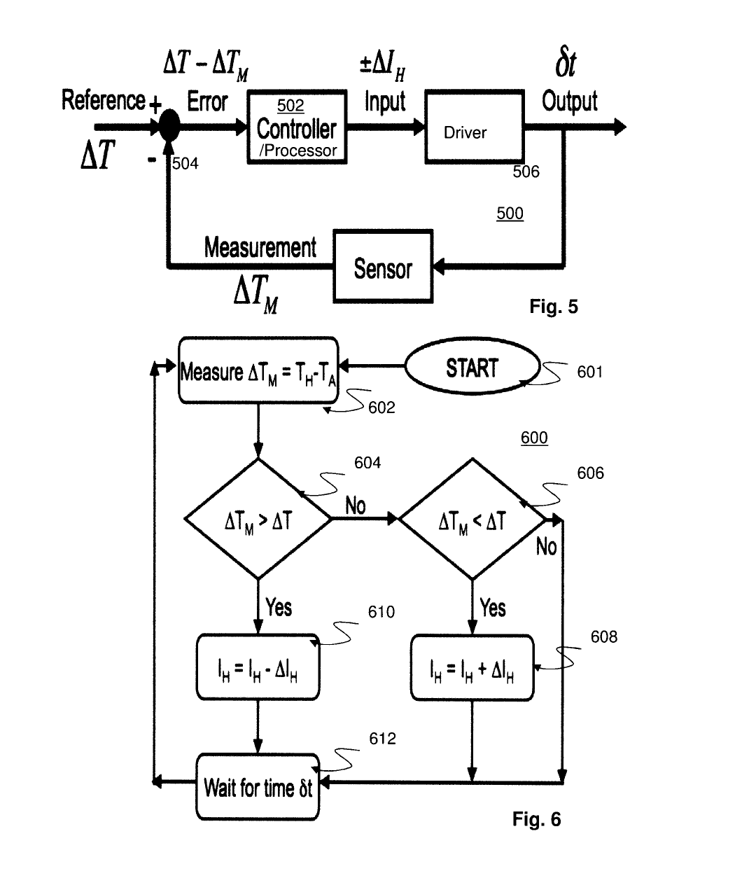

Reference is now made to FIG. 5 which shows a block diagram of a sensor controller 500 for controlling the sensor according to an embodiment of the present matter. Reference is also made to FIG. 6.which shows a flow chart 600 of a sensor control algorithm for the sensor controller 500 according to an embodiment of the present matter. To maintain a constant temperature differential ΔT the heated probe I_{H} current must be raised and lowered dynamically to match changes in the fluid velocity. The sensor controller 500 may be implemented for constant monitoring (via a central processing unit) of each probe in the sensor and a corresponding feedback response in the heater current due to any variation in the temperature differential. The control algorithm is to merely maintain a constant ΔT between the two probes (usually between pump control settle times).

Turning back to FIG. 5, the sensor controller 500 comprises a controller block 502 having a central processing unit, a comparator 504 for producing an error signal based on a difference between an input stored control reference signal representing a desired constant temperature differential ΔT and a sensor signal representing the temperature differential ΔT from the sensor and driver 506 for outputting currents to drive the probe heater element and for setting time delays or time steps, as will be described below. As described with reference to FIG. 3, the current signals from the temperature sensing elements in each probe represent the measured temperature at the probes. These signals may be processed in the digital or analog domain in a manner know to persons in the art to generate the temperature differential ΔT_{M}=T_{H}−T_{A}. The comparator 504 compares the desired constant temperature differential ΔT (which may be input by users or through factory settings) with the measured temperature differential ΔT_{M} to output an error signal ΔT−ΔT_{M} to the controller block 502. In order for the desired constant ΔT to be achieved, such that ΔT_{M}=ΔT, the heater current must be constantly varied by small increments/decrements of ±ΔI_{H}. The value of ΔI_{H} is some fraction of I_{H} at pump off (for example ΔI_{H}=I_{H}/100, which can be defined by users, dynamically, or in the factory).

The controller inputs the error and determines whether to increment or decrement the current I_{H} with respect to the difference ΔT−T_{M} and determines if the error signal representing ΔT−T_{M} (offset between the desired and measured temperature differential) is greater than a sensing resolution of the platinum RTDs, then the controller correspondingly raises or lowers the heater current by an amount ΔI_{H}. If (ΔT−ΔT_{M})>0 then I_{H} is increased by an amount +ΔI_{H}. If (ΔT−ΔT_{M})<0 then I_{H} is decreased by an amount −ΔI/_{H}. After the increment or decrement of I_{H} the system may wait for a time interval δt for the probe system to respond). The time step of δt may be some fraction of a pump settle time (which can also be defined by users, dynamically, or in the factory).

After this short wait time, the differential between the two probes is then measured by the RTD “sensor(s)” resulting in an output ΔT_{M} and the whole process is then subsequently repeated as illustrated by the loop in FIG. 6.

As will now be appreciated, the value of ΔI_{H} may be determined empirically by for example measuring the current required to raise the heated probe mean temperature above a predetermined value of the platinum RTD noise margin in ambient air. Ambient air provides a lower limit on the heat convection constant h, the probe is therefore most sensitive to the input heater current under these conditions.

Similarly, a reasonable sampling interval is needed to insure that the heater current can match the flow rate and achieve ΔT_{M}=ΔT within the settling time of a variable speed pump. Too short a response time, can result in over-damping of the heater current. It takes time for the power increase in the heater resistor to diffuse within the probe to the platinum RTD. An appropriate sampling time can be determined empirically under ambient air conditions.

The sensor 300 may be used in conjunction with a pump controller to control a pump. Benefits of using the present sensor in a pump controller is to optimize production and to extend the life-span of a variable speed pump (pc pumps, other down-hole pumps and pump jacks, etc.).

In order to better understand how the sensor may be used with a pump controller, consider first relationship in Equation (3). This equation can be re-written as

Iₕ²=a(b+c√v) (5)

where a, b and c are empirical constants.

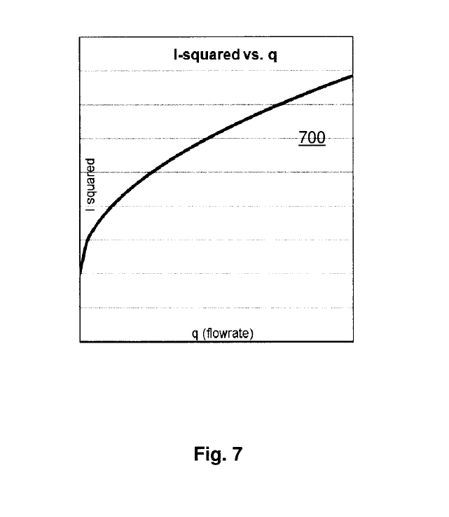

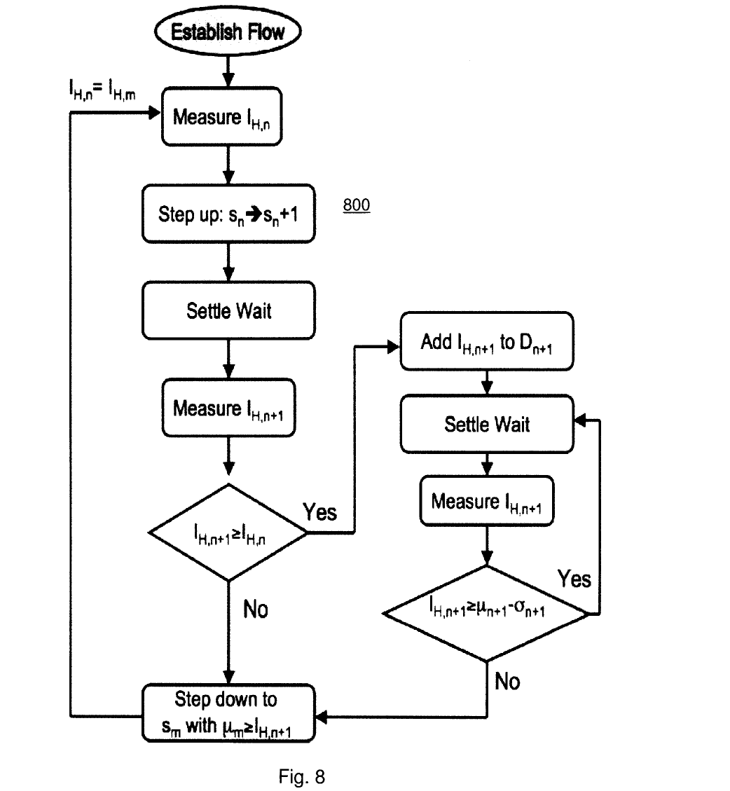

Referring to FIG. 7 a graph of Iₕ² versus flowrate is illustrated. The relationship (5) above gives rise to a square-root dependence of Iₕ² on v, with y intercept on the graph ab.

Since the flow rate q is proportional to v (i.e. q=Av, where A is the cross-sectional area of the flow pipe), the relation becomes:

Iₕ²=a(b+d√v) (6)

where d is also an empirical constant with the same square-root dependence theoretically, and likely a fractional power dependence in practice—since, the relationship is often device dependent (i.e. pump dependent). However, Equation (6) describes the general dependency of a heater current (controlled to maintain a constant temperature differential ΔT) under increasing flow conditions. This relationship states: that if the flow increases, then the current I_{H} supplied to maintain a constant temperature differential (ΔT between the ambient and heated probes) should also increase. However, beyond this general statement, the precise nature of the relation between the fluid velocity and pump speed is dependent on pump size, stator/rotor material, hydrostatic head and pump efficiency (efficiency itself depends on the pump design parameters and can vary somewhat for in-situ conditions). For guidance to operate the pump in the field, if required, one can (using polynomial regression) produce a calibration curve for I_{H}² versus q as shown in FIG. 4. The non-linearity can be accommodated by lower order polynomial fits up to degree 3. The y-intercept, which essentially corresponds to IH2 value for the no-flow should be held fixed during the regression analysis. The control method can be used to measure flow either with factory calibration or with field calibration or with both factory and field calibrations.

Therefore, to control pump under these complex conditions, I_{H} may be implemented as the control variable in the control algorithm outlined by S. Bevan and T. Lownie in their patents titled “Apparatus and method for controlling the speed of a pump in a well” U.S. Pat. No. 7,762,339 and “System and method for controlling pumping of non-homogenous fluids” U.S. Pat. No. 7,044,714. Specifically, with regard to these patents, the heater current I_{H} could replace variable ΔT in the control algorithm table, such that pump speed would always be increased so long as I_{H} increases between settle times. In relation to these earlier patents, the time required for the measurement of I_{H} (in relation to fluid flow) can be called the “settle time” and the time between changes in I_{H} is called the “settle interval”. The settle time and interval are factory set, but can be changed by the user depending on the application. The general logic to be used in FIG. 6, will increase or decrease the heater current I_{H} at rate that is much faster than the settle time/interval, such that the heater current approaches a steady state value within the settle period and can be used as an indirect measure of the flow velocity (for a constant ΔT). The accuracy of the ΔT measurement properties will be based on the tolerance (accuracy) of the particular RTD used. Lastly, it should be mentioned that the desired constant value of ΔT may be set to fit the pumping conditions and fluid heat conductivity.

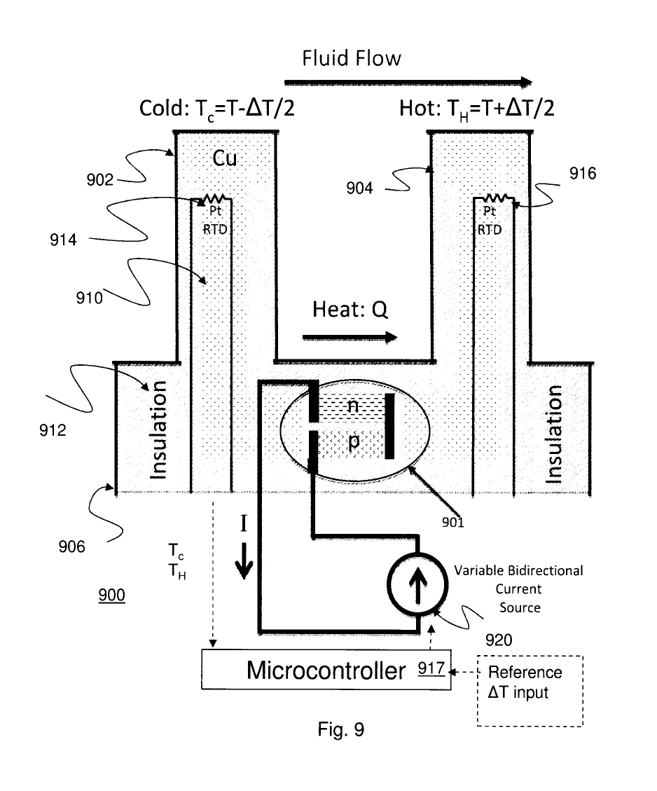

To address flow control in high temperature fluids there is provided a sensor with a cooled probe according to a second embodiment of the present matter. Referring now to FIG. 9 there is shown a cross section of thermoelectric sensor 900 according to the second embodiment of the present matter. The thermoelectric sensor 900 has a pair of probes 902 and 904 extending from a base section 906 and arranged similarly to the sensor 300, described herein. The sensor 900 includes a thermoelectric module 901. Thermoelectric modules are very simple solid state devices with two basic modes of operation. The first mode, based on the Peltier Effect, involves of the application of current through the module, absorbing heat from one side of the device and emitting from the other side (cold and hot faces). Conversely, the Seebeck Effect and second mode of operation can be used for power generation purposes. When a temperature gradient is applied across the thermoelectric module an electric current is produced. Thus the constant temperature differential as described above may also be achieved by cooling one of the probes. This cooling may be implemented by a heat sink, such as a the thermoelectric operating in the first mode.

The thermoelectric module 901 is placed in the base and generally centrally between the probes and in each probe a copper (Cu) conductor 910 conducts heat energy to and from the probes and the thermoelectric module (other highly conductive metals can be used). Suitable insulation material 912 surrounding the copper conductors prevents the thermoelectric unit from heating or cooling other portions of the probe side wall. Temperature sensor elements, such as platinum RTDs (or other RTDs) 914, 916 described with reference to the sensor 300 may be implemented to provide temperature information about each of the probes to a microcontroller 917. These temperature sensors are generally located in each probe 902, 904. A variable bidirectional power source 920 is connected to the thermoelectric module 901 across the P-N junction in a manner known in the art. The reversible (bidirectional) variable current source 901 allows alternate probes to be heated and cooled depending on the direction of current flow (I). In other words each of the plate sides of the thermoelectric module is coupled via the copper conductor to a respective probe. By reversing the current in the source 920, the thermoelectric module will heat/or cool either the probe 902 or 904.

The operation of the thermoelectric sensor 900 may be explained as follows. The sensor operates on the principle that heat energy Q from one probe is pumped to the other probe. The variable current source allows alternate probes to be heated and cooled depending on the direction of current flow (I). The microcontroller is used to control and vary the current to the thermoelectric unit, thereby controlling the amount of heat (Q) pumped from one probe to another.

This may be more clearly understood by considering the operating behavior of the thermoelectric unit 900. The heat flow Q for the thermoelectric module is defined by:

Q=STI−KΔT−I²R/2

where

Q: Heat flow

I: Current from the variable (bidirectional) current source 920.

S: Seebeck coefficient (varies with temperature)

T: Ambient temperature of external fluid.

T_{H}: Temperature of the hot probe (904), measured by platinum RTD.

T_{C}: Temperature of the cold probe (902), measured by platinum RTD.

ΔT: Temperature difference between the two probes due to the heat Q pumped when a current is passed through the thermoelectric

R: Resistance of the thermoelectric

Since S (the Seebeck coefficient) varies with temperature for any given thermoelectric material, a look-up table (not shown) may be stored in the microcontroller 917 to determine the amount of current I required to transfer the desired amount of heat Q to produce the required ΔT as measurable by the platinum RTDs.

Different thermoelectric material designs may be required for different operating temperatures (again due to variability in S). The current I required to produce a programmable zero flow temperature difference ΔT might be calibrated at the beginning of each table build. A suitable method and system for this is for example described in US Publication No. 2006/0204365, Bevan et. al.

As mentioned above, the operating behavior of the thermoelectric is defined by:

Q=STI−KΔT−I²R/2

For a given constant I, determined at the beginning of a table build according to the Seebeck coefficient (S) at the fluid temperature T, we increase the flow. Increasing flow makes the cold probe hotter and the hotter probe colder (while maintaining the same I). Hence, as flow increases ΔT decreases. In other words the thermoelectric operates as a heat pump. In general terms the thermoelectric may be thought of as “cooling” one of the probes.

In an alternate design only one probe is cooled by the thermoelectric, such that the heat Q is pumped out of the fluid into a heat sink outside the probe. The second probe is kept at the ambient fluid temperature (T).

Thus it may be seen that in the thermoelectric a sensor 900, the constant temperature differential ΔT across the probes is maintained by thermoelectric module current I, which in turn provides an indication of flow. This may then be used in a manner as described previously to control a pump.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method for determining flow in a medium, comprising:
applying thermal energy to at least one probe of a pair of probes, the probes configured for placement in the medium; and
varying the applied thermal energy of the at least one probe to maintain a constant temperature differential between the pair of probes; and
determining a flow from the applied thermal energy while maintaining the constant temperature differential.

2. The method of claim 1, said thermal energy being supplied by an electrical heating element and said flow being determined from a power supplied to said electrical element.

3. The method of claim 2, said heating including coupling a power source to the heating element in the at least one probe.

4. The method of claim 3, including incrementing or decrementing the power provided by the power source for said varying.

5. The method of claim 2, said heating element being a resistor.

6. The method of claim 2, said heating element being a thermoelectric module.

7. The method of claim 6, including locating said thermoelectric module between said probes.

8. The method of claim 1, said thermal energy being supplied by a thermoelectric element to cool said at least one probe and said flow being determined from a power supplied to said thermoelectric element.

9. A system for determining flow in fluid comprising:
pair of probes;
a thermal energy element connectable to at least one of said probes, the thermal energy element for heating or cooling at least one probe to maintain a constant temperature differential across the pair of probes; and
a controller for determining a flow from a power provided to said thermal energy element to maintain said constant temperature differential.

10. A thermal dispersion sensor comprising:
pair of probes;
a thermal energy element connectable to at least one of said probes, the thermal energy element for heating or cooling at least one probe ( );
a variable power source connectable to said thermal energy element); and
controllable to vary power provided to said thermal energy element;
temperature sensing elements for sensing a temperature of said probes; and
a microcontroller for receiving temperature information from said temperature sensing elements and for controlling said variable power source to maintain a constant temperature differential across said probes.

11. The thermal dispersion sensor of claim 10, wherein the thermal energy element is a resistor for said heating.

12. The thermal dispersion probe of claim 10, wherein the heat source is a thermoelectric module for said cooling.

13. The thermal dispersion probe of claim 10, wherein a flow is determined by said microcontroller by using a value of said power provided to said thermal energy element at said constant temperature.

14. A microcontroller for a thermal dispersion sensor, the microcontroller comprising a processor configured to implementing the method of claim 1.

15. A pump control system comprising a thermal dispersion sensor according to claim 10.
